(19) United States
(12) Patent Application Publication
(10) Pub. No.: US 2024/0330869 A1
(43) Pub. Date: Oct. 3, 2024

(54) ELECTRONIC CALENDAR SUGGESTIONS BASED ON PAST MEETING DATA

(71) Applicant: Lenovo (Singapore) Pte. Ltd., Singapore (SG)

(72) Inventors: John C. Mese, Morrisville, NC (US); Arnold Wekser, Morrisville, NC (US); Mark Delaney, Morrisville, NC (US); Nathan Peterson, Morrisville, NC (US); Russell Speight VanBlon, Morrisville, NC (US)

(21) Appl. No.: 18/191,274

(22) Filed: Mar. 28, 2023

(51) Int. Cl. G06Q 10/1093

(52) U.S. Cl. CPC G06Q 10/1095

(57) ABSTRACT

In one aspect, a device includes a processor and storage accessible to the processor. The storage includes instructions executable by the processor to access metadata regarding at least one past meeting that is indicated in an electronic calendar and to process the metadata to identify a suggestion to present to a user. The suggestion might relate to whether the user would like to remove an indication of a future meeting from the electronic calendar and/or whether the user would like to change an expected attendance status for the future meeting. The instructions are also executable to, based on identification of the suggestion, present the suggestion using the device.

### FIELD

The disclosure below relates to technically inventive, non-routine solutions that are necessarily rooted in computer technology and that produce concrete technical improvements. In particular, the disclosure below relates to electronic calendar suggestions based on past meeting data.

### BACKGROUND

As recognized herein, electronic calendars present issues that traditional calendars do not. Among these issues is that other people often electronically add an event to a user's electronic calendar without consulting with the user, thereby scheduling some of the user's time when the other person does not even know if the user truly has the time or if the user wants to meet in the first place. If that weren't bad enough, excessive electronic bookings can also lead to the user's unavailability for other meetings that others might wish to book with the user and that the user themselves considers to be of higher importance. Excessive electronic bookings can also lead to overloading the user's electronic calendar with unnecessary meetings that can detract or distract from the user's primary work. The modern remote work environment has compounded these issues exponentially since the number of video conferences coordinated through electronic calendars has itself increased exponentially. There are currently no adequate solutions to the foregoing computer-related, technological problems.

### SUMMARY

Accordingly, in one aspect a device includes at least one processor and storage accessible to the at least one processor. The instructions are executable by the at least one processor to access metadata regarding at least one past meeting that is indicated in an electronic calendar and to process the metadata to identify a suggestion to present to a user. The suggestion relates to whether the user would like to remove an indication of a future meeting from the electronic calendar and/or whether the user would like to change an expected attendance status for the future meeting. The instructions are also executable to, based on identification of the suggestion, present the suggestion using the device.

Thus, in one example implementation the device may include a display accessible to the at least one processor, and the instructions may be executable to present, on the display, a graphical user interface (GUI) indicating the suggestion. The GUI might even include a reason the suggestion is being presented.

In various examples, the metadata may relate to things such as an amount of speech of the user in the at least one past meeting, an amount of time the user had the user's microphone on mute during the at least one past meeting, an amount of time the user had the user's camera off during the at least one past meeting, whether the user actually attended the at least one past meeting, and/or whether the user was on time for the at least one past meeting (e.g., where the user actually attended the at least one past meeting late or on time). Additionally or alternatively, the metadata may relate to whether the at least one meeting is a recurring meeting, whether the at least one meeting is a rescheduled meeting, and/or whether a recording of the at least one past meeting was viewed by the user after the at least one past meeting ended. The metadata might also relate to whether a person other than the user is indicated both on a first participant list for the at least one past meeting and on a second participant list for the future meeting.

In another aspect, a method includes accessing data regarding at least one past meeting that is indicated in an electronic calendar and, based on the data, identifying a suggestion to present to a user. The suggestion relates to whether the user would like to remove an indication of a future meeting from the electronic calendar and/or whether the user would like to change an expected attendance status for the future meeting. The method also includes, based on identifying of the suggestion, presenting the suggestion using an electronic device.

In some examples, the method may specifically include presenting the suggestion responsive to receipt of user input to present the suggestion. Additionally or alternatively, the method may include presenting the suggestion autonomously using the electronic device based on the suggestion being identified.

In still another aspect, at least one computer readable storage medium (CRSM) that is not a transitory signal includes instructions executable by at least one processor to access data regarding at least one past virtual meeting that is indicated in an electronic calendar. The instructions are also executable to, based on the data, use an electronic device to present a suggestion to a user. The suggestion relates to a user's expected attendance status for a future meeting.

Thus, in certain example embodiments the suggestion may relate to whether the user would like to not attend the future meeting and remove an indication of the future meeting from the electronic calendar. Also in certain example embodiments, the suggestion may relate to whether the user would like to change the user's expected attendance status for the future meeting.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example graphical user interface (GUI) that presents a view of an electronic calendar consistent with present principles;

FIG. 4 shows an example GUI that presents a list of suggestions for meetings that the user may wish to act upon;

FIGS. 5 and 6 show example GUIs that may be presented to detail a reason for a given suggestion as well as to provide various particular suggestion options for how the user would like to act on the respective meeting itself;

FIG. 7 illustrates example logic in example flow chart format that may be executed by one or more devices consistent with present principles; and

FIG. 8 shows an example settings GUI that may be presented to configure one or more settings of a device or application (“app”) to operate consistent with present principles.

### DETAILED DESCRIPTION

Among other things, the detailed description below discusses ways to help make a user's electronic calendar reflect the user's actual schedule and availability and to autonomously manage calendar entries. This may be done through a dynamic audit of the calendar to assist in these tasks, for example.

Thus, in one aspect metadata may be recorded and harvested about each meeting on an electronic calendar, and a software agent may then use that information to dynamically generate suggestions (e.g., based on a weighted and/or learned calculation) to the end user to help manage/prioritize the user's work schedule and/or modify meeting responses.

Metadata that may be collected about each meeting includes data regarding frequency of speech in past meetings (e.g., a record of how much a user actually speaks in each particular past meeting). The collected metadata may also include a percentage of time the user's local microphone audio spends on mute during each past meeting that is/includes a video conference in which the local microphone input is streamed to others, as well as an amount of time the local camera spends being powered off or otherwise placed in an off mode during each past meeting that is/includes a video conference in which the local camera input is streamed to others. These factors may be used since they might indicate the user's priority of attending a future similar meeting (e.g., based on past user engagement as evidenced by speech amount, the microphone being on or off, and the camera being on or off).

Additional metadata that may be recorded and harvested includes data of a user's attendance record at past meetings, both absolute (attended or not) as well as punctuality (e.g., late by a recorded amount). These factors may be used since they might indicate that when a user repeatedly misses or is habitually late to a certain meeting type or to a recurring meeting, the user does not consider meetings of the same type or series to be highly important.

Metadata about the meeting type itself may also be recorded and harvested. For example, data may be stored regarding whether a meeting was one of a series of recurring meetings, a single meeting/meeting instance, or even a rescheduled meeting as moved from another time. For example, recurring meetings might indicate a tendency for lower attendance than one-off meetings, while reschedules might bump up importance compared to recurring meetings and other individual meetings as initially established.

What's more, metadata on offline meeting viewing (e.g., recorded viewing) may also be used consistent with present principles and could be a counterbalance in the calculation against the factor of missing/not attending the meeting itself.

Metadata about organizers and a meeting's attendee list may also be used as additional data points to determine trends. For example, if a user frequently or always attends meetings in which another person is also frequently/always listed as an attendee or at least potential attendee, that other person may be added to a “favorites list” for the user so that future meetings for which both the user and person are listed as invitees may be prioritized over meetings with still other individuals with which the user does not regularly or as frequently meet.

Accordingly, metadata may be collected as the user goes about their work and has meetings. As it is collected, the metadata may be included into an AI confidence calculation on whether to surface a suggestion to the end-user that they may want to remove a meeting from their calendar (along with the inferred justification(s) for doing so) or change the attendance response (e.g., switch from “Accept” to “Tentative”). A decay factor of time may also be used to help buffer any non-standard activity. A feature to invoke an audit scan upon user request could also be included to handle on-demand cleanup. Additionally, a manual override or corrective action (like replacing a meeting that was actioned upon) may provide feedback to the calculation and improve the model's accuracy.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

Present principles may employ artificial intelligence (AI) and/or machine learning models, including deep learning models. AI/machine learning models use various algorithms trained in ways that include supervised learning, unsupervised learning, semi-supervised learning, reinforcement learning, feature learning, self learning, and other forms of learning. Examples of such algorithms, which can be implemented by computer circuitry, include one or more neural networks such as a convolutional neural network (CNN) or recurrent neural network (RNN) which may be appropriate to learn information from a series of images, audio, and/or meeting metadata (e.g., a type of RNN known as a long short-term memory (LSTM) network). Support vector machines (SVM) and Bayesian networks also may be considered to be examples of machine learning models.

As understood herein, performing machine learning/model training involves accessing and then training a model on training data to enable the model to process further data to make predictions. A neural network itself may include an input layer, an output layer, and multiple hidden layers in between that that are configured and weighted/trained to make inferences about an appropriate output.

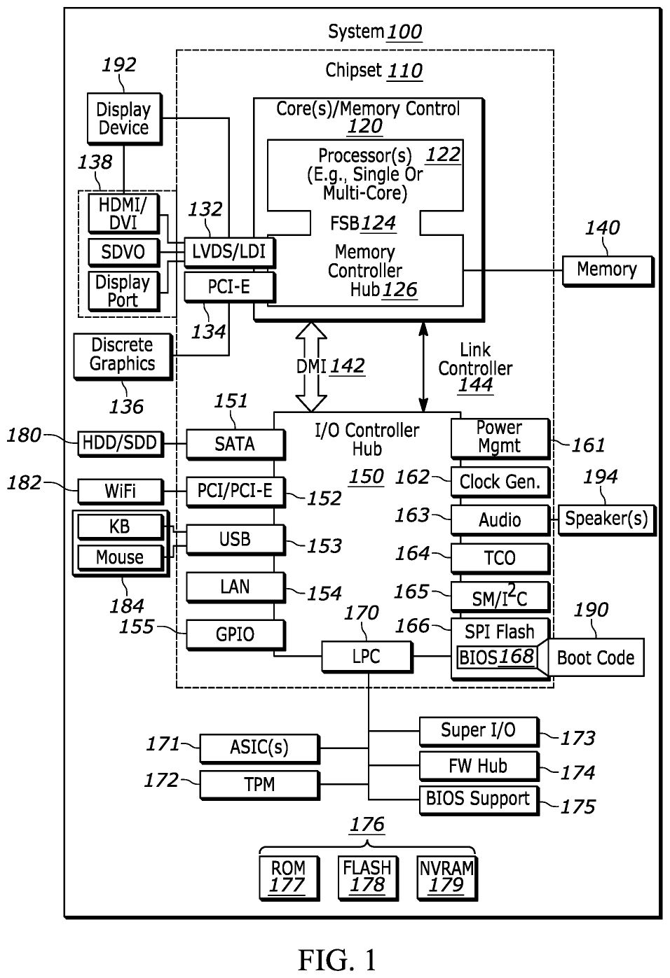

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the

Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, an accelerometer that senses acceleration and/or movement of the system 100 and provides related input to the processor 122, and/or a magnetometer that senses and/or measures directional movement of the system 100 and provides related input to the processor 122. Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

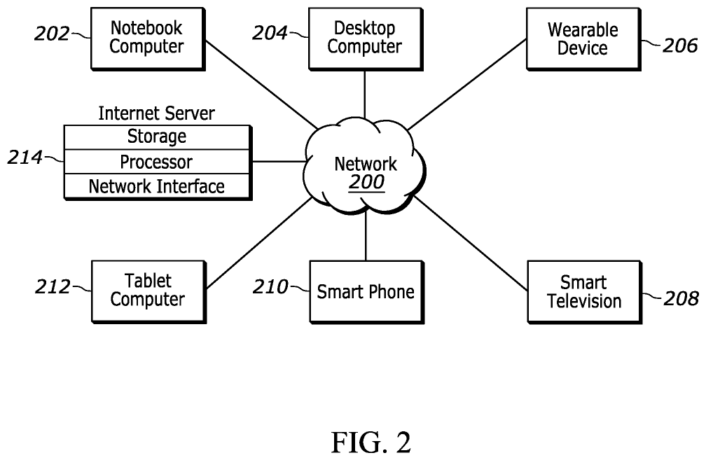

Turning now to FIG. 2, example devices are shown communicating over a network 200 such as the Internet in accordance with present principles, such as to video conference and to exchange metadata about video conferences/electronic meetings. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

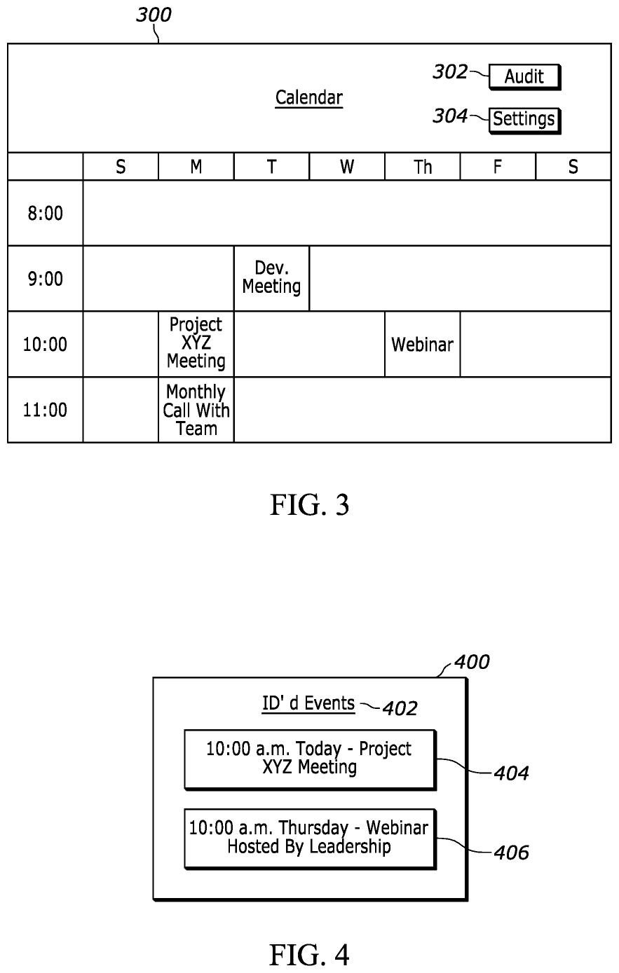

Turning now to FIG. 3, an example graphical user interface (GUI) 300 is shown. The GUI 300 presents a view of an end-user's electronic calendar, with the view in the present instance showing timeslots between 8:00 a.m. and 12:00 p.m. for the days Sunday through Saturday of the current week. As may be appreciated from FIG. 3, the user has various meetings throughout the week.

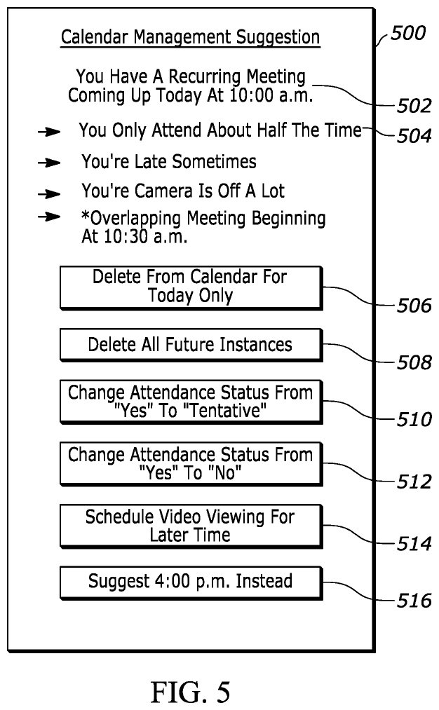

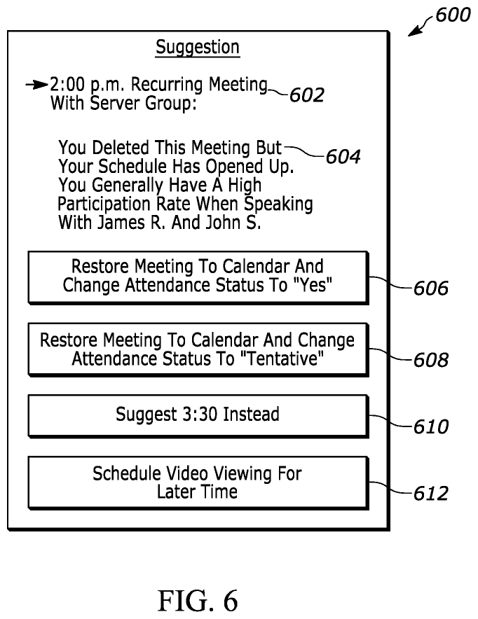

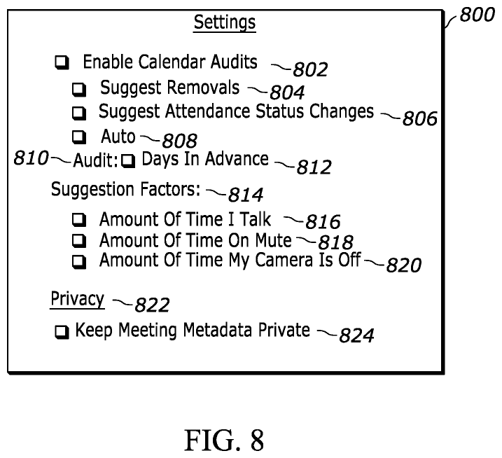

Assume therefore that the user is viewing the calendar on the same Monday morning that is denoted on the calendar view itself. The user might want to organize his/her time for the week, potentially removing certain calendar entries/events and freeing up time for individual projects on which the user has to work. The user might therefore provide input selecting the “audit” selector 302 (e.g., touch or cursor input), which may in turn command the user's client device and/or a remotely-located server (e.g., one that hosts the calendar) to audit upcoming calendar entries/events. In certain non-limiting examples, the audit may only be performed for an upcoming threshold amount of time, such as for the next fourteen days or next month of entries denoted on the calendar. Then responsive to selection of the audit selector 302, the GUIs of FIG. 4 or 5 may be presented. But first also note that should the user so choose, the user may also select the selector 304 from the GUI 300 to instead command the device/server to present a settings GUI instead, such as the example GUI 800 of FIG. 8 that will be described later.

In any case, now in reference to FIG. 4 itself, as indicated above in one example selection of the selector 302 may command the device to present the GUI 400. The GUI 400 may include a list 402 of computer-generated suggestions for certain calendar events that the user might wish to remove from the user's electronic calendar and/or for which the user might like to change an expected attendance status. Continuing with the example from FIG. 3, the list 402 may include a first selector 404 that is selectable to provide user input commanding the device/server to present another GUI with a first suggestion concerning a first meeting scheduled to occur at 10:00 a.m. today (Monday), with the selector 404 indicating the date, time, and/or meeting title depending on implementation.

The list 402 may also include a second selector 406 that is selectable to provide user input commanding the device/server to present another GUI with a second suggestion concerning a second meeting scheduled to occur at 10:00 a.m. on the upcoming Thursday, again with the selector 406 potentially indicating the date, time, and/or full meeting title if desired. The selector 406 might also indicate whom organized or scheduled the meeting as also shown (generally, “leadership” in the present example, though a specific individual's first and last name might also be presented).

Thus, assume as an example that the end-user has provided user input selecting the selector 404 to then view a detailed suggestion GUI concerning the associated first meeting that is scheduled to occur at 10:00 a.m. today. In response, the client device/server may present the GUI 500 of FIG. 5 that indicates detailed computer-generated suggestion(s) relating to whether the user would like to remove an indication (e.g., the entry itself) of the relevant future meeting from his/her electronic calendar, and/or whether the user would like to change an expected attendance status for the future meeting, based on the user's true intention of whether or not to attend that future meeting.

The GUI 500 as shown in FIG. 5 may therefore include a prompt 502 indicating that the user has a recurring meeting coming up today at 10:00 a.m. Beneath the prompt 502 may be a list 504 of one or more reasons that the device/server has identified for presenting the suggestion(s) in the first place. In the present instance, the reasons include that the user only attends the relevant recurring meeting half the time it occurs (indicating the meeting is not of the highest importance to the user), that the user is sometimes late to the meeting (again indicating that the meeting is not of the highest importance), that the user's camera is typically electronically toggled/turned off during the meeting by the user himself/herself (indicating that the user is not typically fully engaged in the meeting anyway), and that the user's calendar indicates another meeting of potentially higher importance that has at least part of its time frame/duration overlapping with that of the 10:00 a.m. meeting. Here, the overlap is half an hour as the 10:00 a.m. meeting is scheduled to last for an hour but the other meeting begins at 10:30 a.m. on the same day.

FIG. 5 also shows that the GUI 500 may include various selectors that themselves indicate various particular suggestions that have been tailored to how the user may want to act on the 10:00 a.m. meeting. This includes a first selector 506 that may be selected by the user to command the device/server to delete the meeting scheduled for today from the user's calendar.

A selector 508 may also be presented and selected by the user to command the device/server to delete all future occurrences of the (recurring) meeting from the user's calendar. So, for example, if the recurring meeting is scheduled to occur every Monday at 10:00 a.m., the calendar entry for the meeting occurring “today” may be deleted as well as the calendar entries for additional instances of the recurring meeting that are scheduled to occur on each Monday in the future.

FIG. 5 also shows that selectors 510 and 512 may be presented on the GUI 500. The selector 510 may be selectable to, in the user's electronic calendar and in the calendars of the other participants registered to participate in the same meeting, change the user's expected attendance status from “yes” to “tentative/maybe”, thus indicating that the user is unsure if he/she will be able to attend the meeting. The selector 512 may be selectable to, in the user's electronic calendar and in the calendars of the other participants scheduled to participate in the same meeting, change the user's expected attendance status from “yes” to “no”, thus indicating that the user will not attend the meeting. In some examples, emails and/or pop-up notifications may even be generated and sent to each of the other participants that indicates the user's current (changed) attendance status.

If desired, in some examples the GUI 500 may further include a selector 514. The selector 514 may be selectable to command the device/server to schedule a viewing of a video recording of the relevant meeting at a later time after the meeting itself ends. The video recording itself may include, for example, audio and video of the meeting as occurred over a video conference between remotely-located people and as recorded by a video conferencing server.

Thus, in one example selection of the selector 514 may command the device/server to autonomously select an available future timeslot in the user's calendar and then dynamically and autonomously generate another calendar event for that timeslot for the user to view the recording during that time. In some instances, an email and/or pop-up notification may even be sent to the user/presented at the user's client device to inform the user of the dynamically-determined time, date, event title, etc. for the autonomously-generated event. However, in other example, selection of the selector 514 may instead command the device/server to open a view of the user's calendar (e.g., the view shown in FIG. 3) for the user to then manually create the additional event to view the recording at a later time. In either case, in some examples selection of the selector 514 and/or the user manually creating the additional event itself may be used as a trigger for the device to delete the 10:00 a.m. meeting from the user's electronic calendar and/or to change an expected attendance status for the user to “no” for the 10:00 a.m. meeting.

As also shown in FIG. 5, in some examples the GUI 500 may include a selector 516 as well. The selector 516 may be selectable to command the device/server to attempt a reschedule of the relevant meeting. Thus, selection of the selector 516 may command the device/server to send electronic requests (e.g., emails/meeting invites) to each of the other registered participants of the meeting, with the electronic requests requesting consent from each participant to change the meeting from its currently-scheduled time of 10:00 a.m. to 4:00 p.m. on the same day. Each request may include a “yes” selector to accept and “no” selector to decline. Then, responsive to each participant accepting the change through their respective request, the device/server may autonomously reschedule the meeting by changing its time and/or copying all provided details and invitees over to the entry for the new time.

Turning now to FIG. 6, another example is shown. Here, suppose that on a different day the end-user had a meeting get canceled or moved. Also suppose that the user had already deleted another meeting from his/her calendar that conflicted with the meeting that was just canceled or moved in that it was scheduled to occur concurrently with the canceled or moved meeting. The user might have already forgotten about the conflicting meeting that was deleted, or might not otherwise think to place it back on the user's calendar. But by adopting present principles related to past meeting metadata analysis, the device/server may autonomously present the GUI 600 shown in FIG. 6 on the user's device.

Accordingly, as shown in FIG. 6 the GUI 600 may include a prompt 602 indicating that the user previously had a different recurring meeting with a server group from the user's company scheduled for 2:00 p.m. today. Beneath the prompt 602 may be a list 604 of one or more reasons that the device/server has identified for presenting the suggestion(s) of FIG. 6. In the present instance, the reasons include that the user had deleted/removed the meeting entry based on the meeting conflict but that the user's calendar has now opened up during the time frame that the deleted recurring meeting was scheduled to occur. The reasons may also include that the user has had a high participation rate in the recurring meeting in the past when speaking with two of its participants (generally designated “James R.” and “John S.” in this example), where those two participants were listed as attendees for one or more previous instances of the recurring meeting and are also listed as invitees for the current instance of the recurring meeting that is scheduled to occur at 2:00 p.m. today.

FIG. 6 also shows that the GUI 600 may include various selectors indicating various particular suggestions that have been tailored to how the user may want to act on this meeting that was deleted from the user's calendar. Thus, a first selector 606 may be selected to command the device/server to restore today's instance of the recurring meeting to the user's calendar for today so that it is indicated on the calendar itself (and so the user potentially receives reminder emails/notifications about it again), and to change an expected attendance status for the meeting to “yes” (e.g., from “no” or “tentative”).

A selector 608 may also be presented on the GUI 600. The selector 608 may be selectable to provide a command to the device/server to similarly restore the recurring meeting instance to the user's calendar for today but to change an expected attendance status for the meeting to “tentative” instead (e.g., from “no”).

As also shown in FIG. 6, in some examples the GUI 600 may include a selector 610. The selector 610 may be selectable to command the device/server to attempt a reschedule of today's instance of the recurring meeting. Thus, selection of the selector 610 may command the device/server to send electronic requests (e.g., emails/meeting invites) to each of the other registered participants of the meeting, with the electronic requests requesting consent from each participant to change the meeting instance from its currently-scheduled time of 2:00 p.m. to 3:30 p.m. on the same day. Each request may include a “yes” selector to accept and “no” selector to decline. Then, responsive to each participant accepting the change through their respective request, the device/server may autonomously reschedule the recurring meeting instance by changing its time and/or copying all provided details over to an entry for the new time in each participant's calendar (including the user's calendar).

FIG. 6 also shows that the GUI 600 may include a selector 612. The selector 612 may be selectable to command the device/server to schedule a viewing of a video recording of the recurring meeting as already scheduled for 2:00 p.m. today for a later time after the meeting ends, similar to as set forth above with respect to the selector 514.

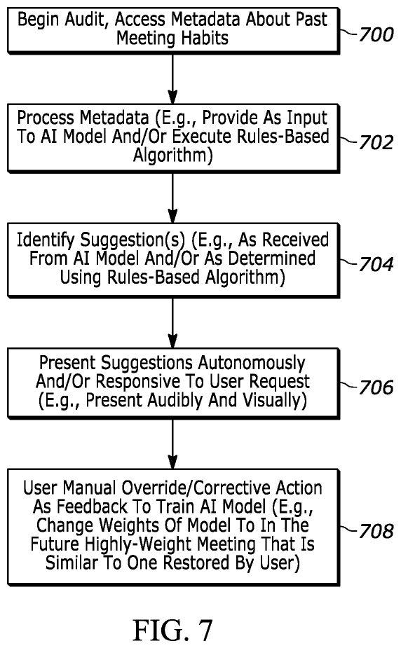

Before describing FIG. 7, note that while passive notifications may be presented in response to user input to do so (e.g., the GUIs 400, 500, and/or 600 being presented responsive to user selection of the audit selector 302), the device/server may additionally or alternatively actively and autonomously present suggestions including those of FIGS. 4-6 based on the suggestions being autonomously identified during an automatic calendar self-audit as well.

Now in reference to FIG. 7, it shows example logic consistent with present principles that may be executed by one or more devices such as a client device and/or electronic calendar-hosting server in any appropriate combination. Note that while the logic of FIG. 7 is shown in flow chart format, other suitable logic may also be used.

Beginning at block 700, the device may begin a calendar audit and access metadata about past meetings indicated in the user's electronic calendar. Thus, as indicated above the audit may begin based on selection of the selector 302 or through other user input (e.g., voice input). However, the audit may also occur autonomously at regular intervals, such as every 24 hours at a designated time of day or every week at a designated time of day.

The metadata that is accessed at block 700 may include a variety of different types of information about the end-user's previous meeting attendance, habits, and engagement. The metadata itself may be gathered and stored by a software application used to host/conduct video conference meetings, by a software application that manages the user's electronic calendar, and/or by another type of app.

Various image processing, sound processing, and other data processing techniques may be used to generate the metadata. For example, gesture recognition, action recognition, object recognition, and other video processing algorithms may be executed on video of a video conference meeting to identify various gestures, actions, and objects from the video feeds of the respective participants of the meeting. Additionally, natural language processing, voice recognition, keyword recognition, and other audio processing algorithms may be executed on audio of the respective participants speaking as part of the past meetings. Metadata about user inputs to the electronic calendar and/or video conference itself may also be collected, indexed, and stored. These types of metadata generation and collection may occur in real-time as a meeting occurs, and/or may occur after the fact using an audio/video recording of the meeting itself as well as past user inputs as already stored as part of the meeting.

As for the types of metadata that may be collected and stored for accessing at a later time, in various examples the metadata may relate to an amount of speech of the user in at least one past video conference/recorded meeting (e.g., a percentage of speech relative to the total speech of all participants), an amount of time the user had the user's microphone on mute during at least one past video conference/recorded meeting, and an amount of time the user had the user's camera off during at least one past video conference/recorded meeting.

The metadata may also be related to whether the user actually attended the past meeting(s). This might be determined based on the user responding “no” to the associated meeting invite/calendar event itself, based on the user not actually logging in to the meeting if the meeting was a video conference, and/or based on the user not being recognized as actually attending/present at the meeting if the meeting was in-person with others. So, for example, user presence at an in-person or partially in-person meeting may be determined using video of the meeting room from a local camera and execution facial recognition, using audio from the meeting room from a local microphone and voice recognition, using wireless signal identifier for wireless signals emitted by the user's personal device and received by a conferencing hub in the meeting room, etc.

Furthermore, in addition to whether the user actually did or did not attend the meeting in the past (e.g., at any point during the meeting's duration), metadata stored for subsequent access at block 700 may include metadata related to whether the user was on time for the past meeting(s) that the user did in fact actually attend at some point (e.g., attended for the entire duration or at least for some recorded time span/amount of time). The same techniques used in the paragraph immediately above may be similarly used here for generating such metadata (e.g., user login time and logout time, time at which the user's face was recognized and time at which the user's face was no longer recognized, etc.).

Additional examples of metadata that may be collected and stored for access later during an audit include metadata related to whether the past meeting was a recurring meeting (e.g., since a future instance of a similar recurring meeting may be weighted less algorithmically based on its tendency to have lower attendance/importance than a single-instance one-off meeting), and metadata related to whether the at least one meeting is a rescheduled meeting (since a meeting rescheduled from a previous or different time may be weighted more algorithmically based on its tendency to have higher attendance/importance since it was important enough to reschedule rather than just cancel).

As another example, the metadata may be related to whether a recording of the past meeting(s) was viewed by the user after the at least one past meeting ended. This metadata may be used based on the recognition that offline, after-the-fact meeting viewing may be weighted more algorithmically based on its apparent importance to the user for the user to actually go back to view some or all of it. So in certain examples, this type of metadata might even algorithmically counterbalance other metadata about the meeting itself being unattended by the user when it actually transpired. Furthermore, the device or system may even track what particular segments or portions of the recording where viewed after the fact, whether those segments were defined by an electronic meeting agenda/schedule as input by an organizer or whether those segments were dynamically determined on the fly and broken down by speaker using voice recognition so that the device may track if the user is specifically watching recorded portions of one particular attendee speaking. This type of metadata might even be used in combination with another factor of the same speaker from the recording being a listed invitee of a future meeting to then determine that the user may not want a suggestion to remove the future meeting from the user's calendar or may even want a suggestion to not miss/delete the future meeting if the user attempts to delete it from the user's calendar themselves.

As yet another example, as intimated above the metadata may be related to whether a person other than the user is indicated both on a respective participant list for the respective past meeting(s) and on another participant list for the future/scheduled meeting that is upcoming. This metadata may be used based on the recognition that users might be more engaged with people they meet with regularly and hence a meeting between regularly-meeting people may be prioritized and weighted higher algorithmically than other meetings between people that have not met before or do not meet as frequently or as much.

Still in reference to FIG. 7, from block 700 the logic may proceed to block 702 for the device to process the metadata. For example, the metadata may be processed through a rules-based algorithm that is executed to provide suggestions consistent with present principles. The rules-based algorithm may incorporate aspects discussed above, such as suggesting a meeting for restoration to the user's calendar that lists other participants with which the user has met at least one time in the past. Or a recurring meeting an instance of which has already been canceled or not attended at least once in the past may be suggested for cancellation/removal again in the future. As another example, if the user had their microphone on mute and/or camera turned off for at least a threshold amount of time in a recurring meeting instance that occurred in the past, and/or spoke less than a threshold amount of time relative to all speech of all participants of the past meeting instance, a future instance of the same recurring meeting may be suggested for cancellation/removal based on that. As yet another example, if a recording of the meeting has been viewed by the user after the meeting itself ends, the device may suggest future attendance at another meeting with one or more of the same participants and/or that concerns a same topic (e.g., as determined from audio or text data for the past meeting using topic segmentation and/or natural language understanding).

As another example that may be used in addition to or in lieu of a rules-based algorithm, to process the metadata the metadata may be provided as input to an artificial intelligence-based machine learning model. The model may be established for example by one or more recurrent and/or convolutional neural networks that have been trained for pattern recognition and suggestion inferences using labeled meeting metadata/metadata combinations. The labels themselves may therefore indicate different resulting suggestions for the associated training metadata/combinations. Thus, for example, a system administrator or end-user might provide labeled training metadata (e.g., any of the types of metadata described herein) as input to the model during training to thus train the model to make correct suggestion inferences that conform to the labeled suggestions themselves to then, during deployment, output appropriate meeting suggestions as discussed above.

Additionally or alternatively, the inference outputs of the trained model may indicate a particular level of meeting importance for the relevant meeting (e.g., along a scale from one to ten) for the user's device to then select a highest-ranked meeting from amongst two or more conflicting meetings, where the selected meeting has a highest importance level on the scale and the conflicting meeting(s) of lower importance are then suggested for removal from the user's calendar. Additionally or alternatively, meetings with an inferred importance level at or below a threshold importance level on the scale may be suggested for removal from the user's calendar regardless of whether another conflicting meeting exists. To this end, during training respective metadata may be labeled with respective importance levels to then adjust the weights of the model based on whether the respective output inference matches the label (and adjusting the model's weights if not). Then during deployment the model may process additional metadata that is accessed at block 700 to make similar inferences based on its training.

From block 702 the logic of FIG. 7 may then proceed to block 704. At block 704 the device may identify the suggestions themselves, e.g., as received from the AI model and/or as determined using the rules-based algorithm(s). Thereafter the logic may proceed to block 706 where the device may autonomously present the suggestions to the user and/or present the suggestions responsive to user request. For example, at block 706 the device may present the suggestions audibly via speakers and/or visually on a display of the user's device.

From block 706, in some examples the logic may then proceed to block 708. At block 708 the device may use any manual overrides/corrective actions taken by the end user himself/herself as feedback to further train the AI model that might have been used. For example, the weights of the model may be changed to highly-weight or more highly-weight a meeting that has been restored to the calendar by user, or that is similar to one that has been restored by the user, after being auto-deleted or deleted by the user themselves. Or if a meeting that was deemed to be of high importance by the device and hence was not initially suggested for removal is then removed from the user's calendar by the user themselves, this user input may be used as training to change the weights of the model to lower-weight a similar meeting scheduled to occur in the future (and potentially suggest it for removal from the user's calendar).

Continuing the detailed description in reference to FIG. 8, it shows an example GUI 800 that may be presented on the display of a client device to configure one or more settings of the device and/or a user's electronic calendar to operate consistent with present principles. The GUI 800 may be presented based on a user navigating a device or calendar app menu, for example. The GUI 800 might also be presented based on selection of the selector 304 discussed above. Also note that each of the example options and sub-options described below may be selected via touch, cursor, or other input directed to the associated check box per this example.

As shown in FIG. 8, the GUI 800 may include a first option 802 that may be selectable a single time to set/configure the device to, for multiple future instances, audit a user's electronic calendar consistent with present principles. For example, option 802 may be selected to set or configure the device to perform calendar audits autonomously at regular intervals and/or upon user request. Option 802 may in some examples be accompanied by sub-options 804-808. Sub-option 804 may be selectable to specifically set or configure the device to suggest removal of meetings consistent with present principles, while sub-option 806 may be selectable to specifically set or configure the device to suggest attendance status changes for various meetings consistent with present principles. Sub-option 808 may be selectable to specifically set or configure the device to perform calendar edits and present corresponding suggestions autonomously rather than merely passively based on input to a selector like the selector 302.

If desired, the GUI 800 may include a setting 810 at which the end-user may establish a number of days in advance for which calendar events scheduled for those days should be audited. The interval may be established by directing numerical input to input box 812 to indicate a particular number of days in advance for which calendared meetings are to be analyzed to then make suggestions on whether to remove or change an attendance status for the relevant meetings. For example, if the user were to establish the number of days as five days, when a calendar audit is initiated it may analyze all scheduled meetings that are to occur in the next five days. By limiting the amount of calendar entries that are audited during any given audit, the device may therefore conserve processor resources and save power.

As also shown in FIG. 8, in some examples the GUI 800 may include a setting 814 listing various options for various types of metadata of past meetings that may be analyzed for making suggestions about future meetings. Any of the types of metadata described herein may be listed on the GUI 800, with only three types actually being shown in FIG. 8 for simplicity. Thus, option 816 may be selected to select an amount of time the user has talked in one or more past meetings as a factor, option 818 may be selected to select an amount of time the user had the user's microphone on mute during one or more past virtual meetings (e.g., video conference or partial video conference) as a factor, and option 820 may be selected to select an amount of time the user had the user's camera off during one or more past virtual meetings as a factor.

If desired, in some examples the GUI 800 may also include a privacy section 822 at which one or more privacy options may be enabled. This includes an option 824 that may be selectable to command the device/calendar host to keep the user's past meeting metadata private and not share the data with third parties like service providers, advertisers, business partners, etc.

With FIG. 8 having now been described, it is to be noted that in some examples a decay factor may also be used to help buffer/down-weight any non-standard activity for which metadata is generated. For example, if a user happens to miss one meeting of a recurring meeting series and otherwise attends each meeting in the series, the weight given to the metadata that is generated for not attending that one meeting may be reduced over time. This may be done so that, e.g., the device does not render false positives where it repeatedly surfaces a suggestion for the user to remove future instances of the recurring meeting from the user's calendar when the user actually still wants to attend and not be bothered by such suggestions. As another example, if the user happened to highly-participate in a single instance of a particular recurring meeting or meeting type, but otherwise does not participate highly in that recurring meeting/meeting type during other instances, then the weight given to the metadata that is generated for the high-participation meeting may be reduced over time so that the device does fail to make suggestions to remove future instances of the same recurring meeting (or meetings of the same type) from the user's calendar when it otherwise should. Thus, while in some examples the decay factor may be a constant rate of decay over time, in other examples it may be an exponentially decreasing rate of decay over time to help quickly reduce false positives.

Also note that a manual override or corrective action (like replacing/restoring a deleted meeting from its current location in an event trash can) may provide feedback during training for the AI model that is used to thus improve the model's accuracy. Thus, meetings that were restored or reinstituted may be used to infer a high priority in the user attending that meeting or similar meetings of the same type in the future.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and comprising instructions executable by the at least one processor to:
access metadata regarding at least one past meeting that is indicated in an electronic calendar;
process the metadata to identify a suggestion to present to a user, the suggestion relating to one or more of: whether the user would like to remove an indication of a future meeting from the electronic calendar, whether the user would like to change an expected attendance status for the future meeting; and
based on identification of the suggestion, present the suggestion using the device.

2. The device of claim 1, comprising a display accessible to the at least one processor, and wherein the instructions are executable to:
present, on the display, a graphical user interface (GUI), the GUI comprising the suggestion.

3. The device of claim 2, wherein the GUI comprises a reason the suggestion is being presented.

4. The device of claim 1, wherein the metadata relates to an amount of speech of the user in the at least one past meeting.

5. The device of claim 1, wherein the metadata relates to an amount of time the user had the user's microphone on mute during the at least one past meeting.

6. The device of claim 1, wherein the metadata relates to an amount of time the user had the user's camera off during the at least one past meeting.

7. The device of claim 1, wherein the metadata relates to whether the user actually attended the at least one past meeting.

8. The device of claim 1, wherein the metadata relates to whether the user was on time for the at least one past meeting, the user actually attending the at least one past meeting late or on time.

9. The device of claim 1, wherein the metadata relates to whether the at least one meeting is a recurring meeting.

10. The device of claim 1, wherein the metadata relates to whether the at least one meeting is a rescheduled meeting.

11. The device of claim 1, wherein the metadata relates to whether a recording of the at least one past meeting was viewed by the user after the at least one past meeting ended.

12. The device of claim 1, wherein the metadata relates to whether a person other than the user is indicated both on a first participant list for the at least one past meeting and on a second participant list for the future meeting.

13. A method, comprising:
accessing data regarding at least one past meeting that is indicated in an electronic calendar;
based on the data, identifying a suggestion to present to a user, the suggestion relating to one or more of: whether the user would like to remove an indication of a future meeting from the electronic calendar, whether the user would like to change an expected attendance status for the future meeting; and
based on identifying of the suggestion, presenting the suggestion using an electronic device.

14. The method of claim 13, wherein the suggestion relates to whether the user would like to remove the indication of the future meeting from the electronic calendar.

15. The method of claim 13, wherein the suggestion relates to whether the user would like to change the expected attendance status for the future meeting.

16. The method of claim 13, comprising:
presenting the suggestion responsive to receipt of user input to present the suggestion.

17. The method of claim 13, comprising:
presenting the suggestion autonomously using the electronic device based on the suggestion being identified.

18. At least one computer readable storage medium (CRSM) that is not a transitory signal, the at least one CRSM comprising instructions executable by at least one processor to:
access data regarding at least one past virtual meeting that is indicated in an electronic calendar; and
based on the data, use an electronic device to present a suggestion to a user, the suggestion relating to a user's expected attendance status for a future meeting.

19. The CRSM of claim 18, wherein the suggestion relates to whether the user would like to not attend the future meeting and remove an indication of the future meeting from the electronic calendar.

20. The CRSM of claim 18, wherein the suggestion relates to whether the user would like to change the user's expected attendance status for the future meeting.
